(19) United States
(12) Patent Application Publication
(10) Pub. No.: US 2006/0118177 A1
(43) Pub. Date: Jun. 8, 2006

(54) Coated valve and method of making same

(76) Inventor: Robert C. Ucman, Haslett, MI (US)

Correspondence Address: THOMPSON HINE L.L.P., P.O. BOX 8801, DAYTON, OH, 45401-8801, US

(21) Appl. No.: 11/289,846

(22) Filed: Nov. 30, 2005

Related U.S. Application Data
(60) Provisional application No. 60/633,819, filed on Dec. 7, 2004.

(51) Int. Cl. F16L 7/00

(52) U.S. Cl. 137/375

(57) ABSTRACT

A method of making a valve for use in a combustion engine includes forming a valve core of a titanium material, the valve core including a head and an elongated stem extending away from the head with a curved region connecting the head and the elongated stem. The elongated stem includes a central guide region that is substantially uniform in outer dimension and free of any undercut. Surface portions of the valve core are finished to a suitable roughness average, the finishing occurring at least in the central guide region of the elongated stem. A coating process is used to apply and bond a multi-layer coating to finished surface portions of the valve core including the central guide region of the elongated stem.

### CROSS-REFERENCE TO RELATED APPLICATION

This application claims the benefit of U.S. Provisional Patent Application Ser. No. 60/633,819, filed Dec. 7, 2004, the entirety of which is incorporated herein by reference.

### TECHNICAL FIELD

The present application relates to valves and more particularly to a coated valve for use in an automobile engine.

### BACKGROUND

Intake and exhaust valves are used to control flow of fluid into and out of a combustion chamber of an engine utilizing a machined seating surface that can mate with a corresponding valve seat. Typically, the valves include an enlarged head including the seating surface and a stem that can be mechanically linked to a control system for controlling movement of the valves. During use, the valves reciprocate within a guide sleeve, opening and closing respective passageways in communication with the combustion chamber.

To reduce wear on the valve due to sliding contact with the guide sleeve, valves have been proposed that include a stem having an undercut region that is filled with stainless steel and molybdenum alloy by plasma spraying. This stainless steel and molybdenum alloy spray filling reduces the coefficient of friction between the guide sleeve and the valve.

### SUMMARY

In an aspect, a method of making a valve for use in a combustion engine is provided. The method includes forming a valve core of a titanium material, the valve core including a head and an elongated stem extending away from the head with a curved region connecting the head and the elongated stem. The elongated stem includes a central guide region that is substantially uniform in outer dimension and free of any undercut. Surface portions of the valve core are finished to a roughness average of at most about three micro inches, the finishing occurring at least in the central guide region of the elongated stem and in the curved region connecting the head and the elongated stem. A physical vapor deposition process is used to apply and bond a multi-layer coating to finished surface portions of the valve core including the central guide region of the elongated stem and the curved region connecting the head and elongated stem. The multi-layer coating includes a material with a hardness greater than that of the titanium material.

In another aspect, a valve for use in an engine includes a valve body including a stem portion and an enlarged head portion. The valve body includes a valve core including a titanium material and having a surface polished to a roughness average of at most three micro inches. The valve body further includes a physical vapor deposition coating that has one or more layers of metallic coating material bonded to the polished surface of the valve core.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a side view of an embodiment of a valve;

FIG. 1A is a section view of the valve of FIG. 1 along line A-A;

FIG. 1B is a detail view at area B of FIG. 1A;

FIG. 2 is a diagram of an embodiment of a process of making the valve of FIG. 1; and

FIG. 3 is a section view of the valve of FIG. 1 located in a guide sleeve within a combustion engine.

### DETAILED DESCRIPTION

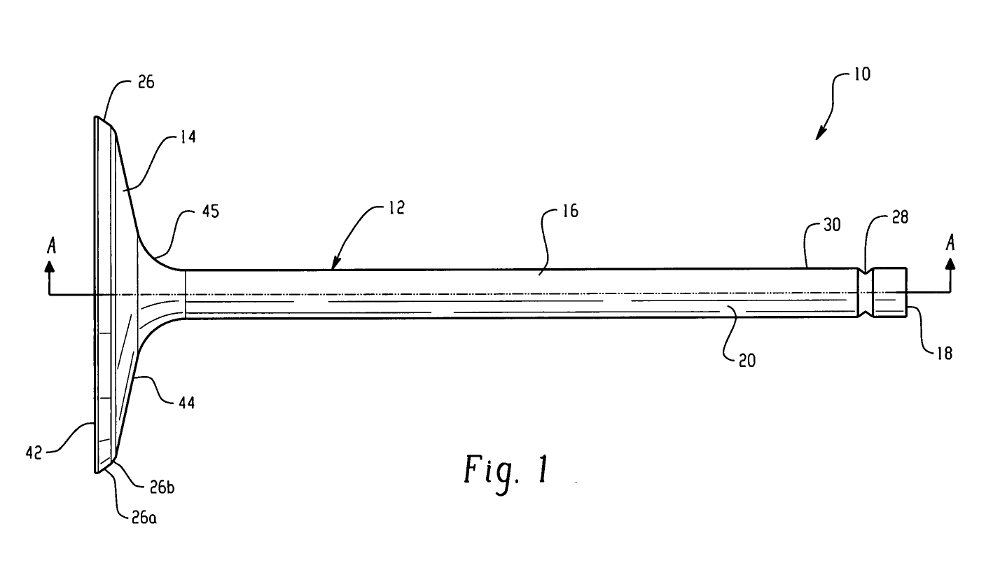

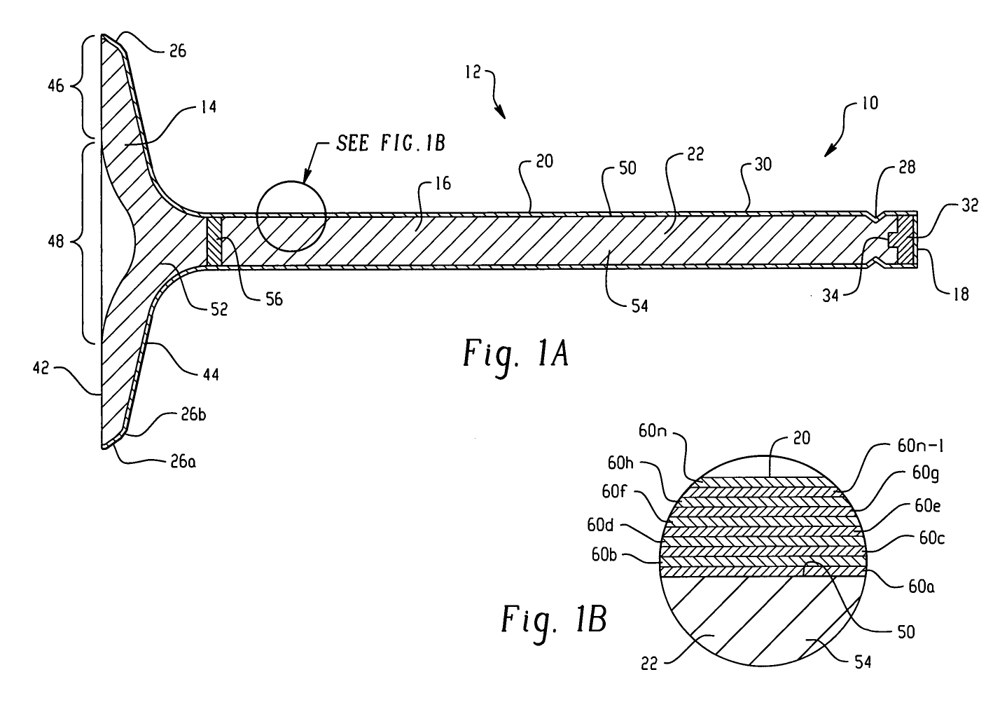

Referring to FIG. 1, a valve 10 (e.g., suitable for use as an intake or exhaust valve of a combustion engine) has a valve body 12 including an enlarged head 14 connected to a stem 16 that extends to a free distal end 18 opposite the head. The head 14 includes an annular seating surface 26 formed along its periphery that can be used to seal an intake or exhaust passageway of a combustion chamber. Referring also to FIGS. 1A and 1B, the valve 10 includes a multilayer physical vapor deposition coating 20 deposited on a micro polished surface 50 of a metal core 22. The multilayer physical vapor deposition coating 20 can improve certain physical characteristics of the metal core, such as lubricity and corrosion resistance, while the micro polished surface can remove surface abnormalities, sometimes referred to as “stress risers” that may lead to valve failure during operation.

The head 14 includes a face 42 and an opposite side 44 from which the stem 16 extends. A contoured surface 45 extends from the outer periphery of the head 14 to the stem 16 providing a radiused transition therebetween. The face 42, as shown in FIG. 1A, has a relatively planar annular portion 46 and a central recessed portion 48 bounded by the planar portion. Recessed portion 48 can be provided to reduce the weight of the valve 10. Alternatively, the face 42 may be flat, with no recessed portion. The seating surface 26 is designed to mate with a corresponding valve seat (not shown). As shown, the seating surface 26 has contoured regions 26a and 26b having linear profiles (see FIG. 1A) that extend at an angle to each other. The seating surface can be of any suitable design for mating with a valve seat.

Extending inwardly from an outer surface 30 at the distal end 18 of the stem 16 is an annular groove 28 (FIG. 1). The annular groove 28 can be used to connect the valve 10 to a valve control system of an automobile engine, for example. To provide reinforcement for the stem 16, for example, when the valve 10 is attached to a rocker arm, an insert 32 (e.g., formed of hardened steel) is disposed within a recess 34 at the distal end 18 of the metal core 22. In other embodiments, the valve 10 does not include the insert 32 or recess 34. In cases where no insert 32 is provided, a lash cap (not shown) may be used to reinforce the stem 16.

Referring still to FIG. 1A, metal core 22 provides the structure to which the multilayer physical vapor deposition coating 20 is bonded. The shape of the metal core is similar to that of the finished valve body 12 in that it includes an enlarged head portion 52 and a stem portion 54. An interface 56 connects the head and stem portions 52 and 54. In some embodiments, the head and stem portions 52 and 54 are formed separately, at least to some degree, (e.g., by forging) and then connected together (e.g., by welding). While the interface 56 is shown as being substantially perpendicular to the elongated axis of the stem portion 54, it can be any suitable configuration, such as angled to provide a relatively smooth transition from the head portion 52 to the stem portion 54.

The surface 50 of the metal core 22 is micro polished, which can remove stress risers that can lead to valve failure during operation. In some embodiments, surface 50 is micro polished to a roughness average (Ra) of no more than about three micro inches. Providing a suitably microfinished, superfinished or polished surface prior to deposition of the hard coating aids in reducing the wear that the coating will cause on the guide ring or guide sleeve. Roughness average (Ra) variations may be possible depending on the hardness of the guide sleeve that will be used. In some embodiments, only a portion (e.g., only the stem portion) of the surface 50 of the metal core 22 is micro polished. Suitable materials for forming the head and stem portions 52, 54 of the metal core 22 may include titanium or titanium alloys, such as Ti-64, Ti-62S, Ti-6246 or Ti-6242-Si.

Referring to FIG. 1B, multilayer physical vapor deposition coating 20 is a composite formed of numerous individual layers 60 of material. As shown, the layers 60a-60n are stacked, one over the other, with each layer bonded to at least one adjacent layer of coating material. In some embodiments, multilayer physical vapor deposition coating 20 includes at least about 1000 layers, such as about 2700 layers. However, the number of layers can be increased or decreased as desired.

The arrangement of the layers 60a-60n can also be selected as desired. The arrangement may depend on, for example, the materials used to form the individual layers. For example, in one embodiment, the multilayer coating is a composite formed of alternating layers of titanium, titanium nitride and tungsten carbide, respectively. In other embodiments, multiple adjacent layers may be formed of the same material. One example of a suitable, commercially available composite coating material is Balnit® Futura Nano, available from Balzers, Inc. of Brunswick, Ohio.

As shown, layers 60a-60n have substantially the same thickness, however, the thicknesses of the layers can vary. The thickness of the individual layers 60a-60n may also depend on, for example, the materials used to form the individual layers or the process used to form the individual layers. By way of example, the total thickness of the multilayer physical vapor deposition coating 20 including layers 60a-60n can be in the range of between about 2×10⁻⁴ and about 16×10⁻⁴ inch (e.g. in the range of between about 5×10⁻⁴ and about 12×10⁻⁴ inch). As one example, the total thickness of the multilayer physical vapor deposition coating is about 8×10⁻⁴ inch. Coating thicknesses of less than and greater than 8×10⁻⁴ inch are also contemplated. A suitable physical vapor deposition coating process is commercially available from Balzers, Inc.

As noted above, the multilayer physical vapor deposition coating 20 improves physical properties of the metal core 22. As shown, the multilayer physical vapor deposition coating 20 covers the entire metal core 22, except at face 42 where the valve body 12 is free of the multilayer physical vapor deposition coating. However, the multilayer physical vapor deposition coating 20 can be bonded to the metal core 22 where desired. In some embodiments, the multilayer physical vapor deposition coating 20 provides a coefficient of friction against steel (dry) of about 0.35, a micro hardness (HV 0.05) of about 3300 and an oxidation temperature of about 1650 degrees Fahrenheit.

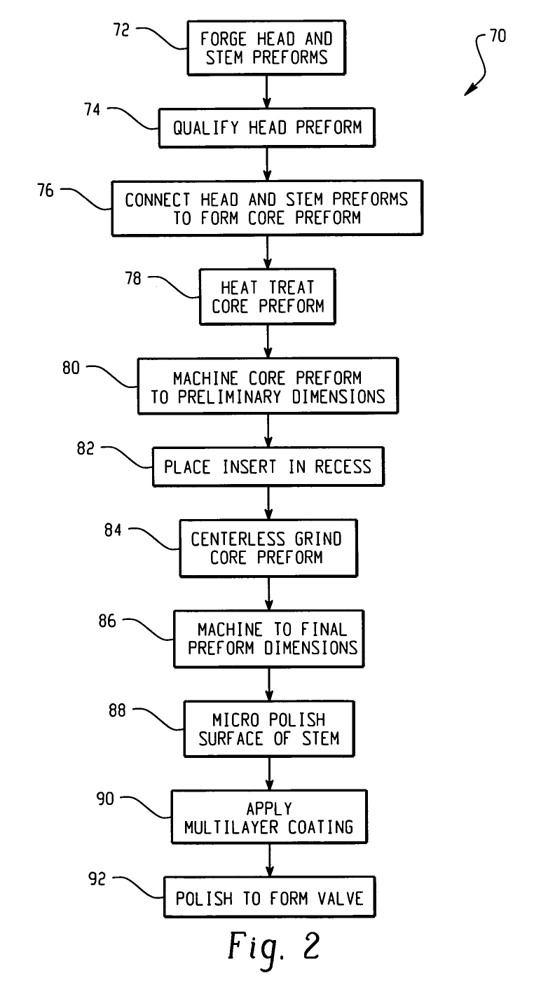

Referring to FIG. 2, a flow diagram 70 of a suitable process for forming the valve 10 is shown. In a forging operation 72, a core head preform and a core stem preform are formed to respective preliminary shapes. The head preform is qualified to a desired shape by a machining operation 74, for example, using a CNC lathe. The head and stem preforms are then connected together by any suitable connecting method 76 such as by friction welding to form a core preform, and the core preform is heat treated at a desired temperature during a heat treating operation 78. After heat treating, the core preform is machined during a machining operation 80 (e.g., using a CNC lathe) to preliminary dimensions and the insert 32 is placed in recess 34 at step 82. Additional material is removed from the stem portion of the core preform by a centerless grinding operation 84 (e.g., to reduce the roughness average (Ra) of the surface to between about 15 and four micro inches, for example, by removing about 4×10⁻⁴ inch of material) and then the core preform is machined at step 86 to final preform dimensions. The stem portion and the curved head portion up to the seating surface 16 are then micro polished during a polishing operation 88, for example, to a roughness average of no more than three micro inches, which can remove surface stress risers caused by surface abnormalities forming the metal core 22. Other portions of the core preform may also be micro polished, such as the face 52. In some embodiments, during micro polishing about 4×10⁻⁴ inch of material is removed. The multilayer coating 20 may then applied to the entire outer surface of the core 22, except on the face 52 of the head in a coating operation 90 (e.g., using a vapor deposition process) and a final polishing operation 92 is performed in which a small amount (e.g., one micro inch or less) of coating material is removed forming the valve 10.

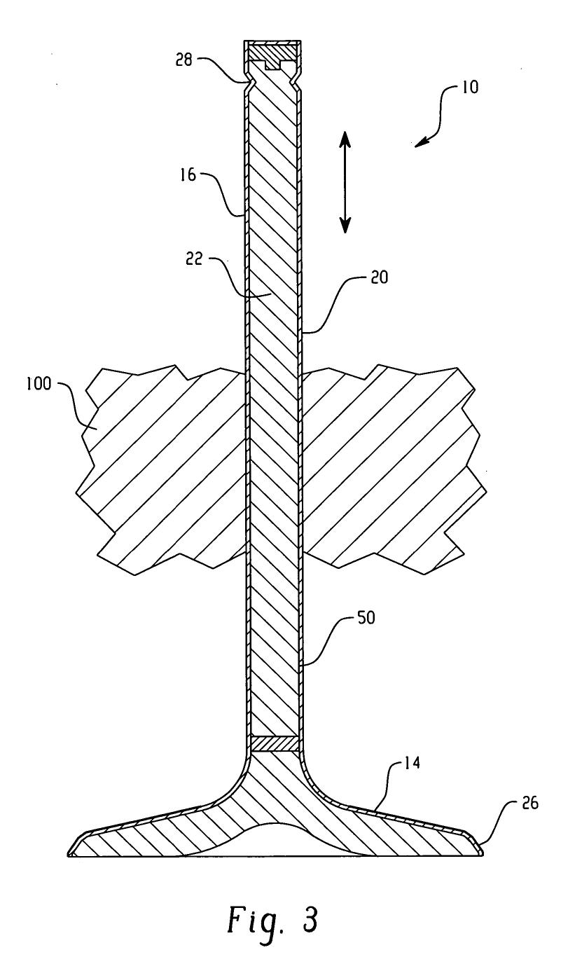

Referring now to FIG. 3, during use, the stem 16 of the coated valve 10 may reciprocate within a guide sleeve 100. The guide sleeve 100 aids in aligning the valve 10 so that the seating surface 26 seats against a valve seat, e.g., to seal a combustion chamber (not shown). The relatively smooth multilayer coating 20, by providing a relatively low coefficient of friction between the valve and the guide sleeve, reduces the wear on the valve due to sliding contact between a central guide region of the stem and the guide sleeve, which can increase the useful life of the valve. The coated, micro polished surface 50 reduces stress risers that can also lead to valve failure. Additionally, the multilayer coating 20 is applied to the micro polished surface 50 of the valve without any need for undercutting the stem portion 54 in the central region of the stem between the annular groove 28 and the head 14, which can improve the strength and durability of the valve 10.

It is to be clearly understood that the above description is intended by way of illustration and example only and is not intended to be taken by way of limitation, and that changes and modifications are possible. For example, in some embodiments, face 52 may be coated with the multilayer physical vapor deposition coating 20. In some embodiments, the metal core may be formed as a single piece, e.g., by a forging operation. Although, coatings by physical vapor deposition have been primarily described, other coating processes can be used. Accordingly, other embodiments are contemplated.

What is claimed is:

1. A method of making a valve for use in a combustion engine, the method comprising:
(a) forming a valve core of a titanium material, the valve core including a head and an elongated stem extending away from the head with a curved region connecting the head and the elongated stem, a central guide region of the elongated stem being substantially uniform in outer dimension and free of any undercut;
(b) finishing surface portions of the valve core of step (a) to a roughness average of at most about three micro inches, the finishing occurring at least in the central guide region of the elongated stem and in the curved region connecting the head and elongated stem; and
(c) using a physical vapor deposition process to apply and bond a multi-layer coating to finished surface portions of the valve core, including the central guide region of the elongated stem and the curved region connecting the head and elongated stem, the multi-layer coating comprising a material with hardness greater than that of the titanium material.

2. The method of claim 1, wherein forming the valve core includes
separately forming a head preform and a stem preform; and
connecting the head and stem preforms.

3. The method of claim 2, wherein the step of connecting the head and stem preforms includes welding the head and stem preforms together.

4. The method of claim 1, wherein the multi-layer coating comprises one or more materials selected from a group consisting of titanium, aluminum nitride and tungsten carbide.

5. The method of claim 1, wherein the multi-layer coating consists of between about 2000 and 3000 layers of coating material.

6. The method of claim 1, wherein the multi-layer coating includes alternating layers of titanium, aluminum nitride and tungsten carbide.

7. The method of claim 1 further comprising forming an annular seating surface along the periphery of the head.

8. The method of claim 1, wherein the head has a face that is free of the layer of the coating material.

9. The method of claim 8, wherein only the face of the head is free of the coating material.

10. The method of claim 1 further including grinding the stem prior to step (b).

11. The method of claim 10, wherein the step of grinding comprises centerless grinding.

12. The method of claim 11, wherein the step of grinding includes grinding the surface of the stem to a roughness average of between four and 15 micro inches.

13. The method of claim 1, wherein the titanium material comprises Ti-6246 or Ti-6242-Si.

14. A valve for use in an engine, the valve comprising:
a valve body including a stem portion and an enlarged head portion, the valve body comprising a valve core comprising a titanium material,
the valve body comprising a physical vapor deposition coating including one or more layers of metallic coating material bonded to microfinished titanium material surface portions of the valve core.

15. The valve of claim 14, wherein the one or more layers comprise a material selected from a group consisting of titanium, aluminum nitride and tungsten carbide.

16. The valve of claim 14, wherein the valve body includes multiple layers of metallic coating material.

17. The valve of claim 14, wherein the multiple layers of metallic coating material are disposed one over the other.

18. The valve of claim 17, wherein adjacent, overlapping layers comprise different respective metallic coating materials.

19. The valve of claim 18, wherein the valve body includes between about 2000 and 3000 layers of metallic coating material.

20. The valve of claim 18, wherein the multiple layers of metallic coating material include alternating layers of titanium, aluminum nitride and tungsten carbide.

21. The valve of claim 14, wherein the head portion has an annular seating surface along its periphery.

22. The valve of claim 14, wherein the head portion has a face that is free of the metallic coating material.

23. The valve of claim 22, wherein only the face of the head portion is free of the metallic coating material.

24. The valve of claim 14, wherein the titanium material comprises Ti-6246 or Ti-6242-Si.

25. The valve of claim 14, wherein the physical vapor deposition coating has a hardness greater than that of the titanium material.

26. The valve of claim 14, wherein the valve core has a central guide region that is substantially uniform in outer dimension and free of any undercut.

27. A method of making a valve for use in a combustion engine, the method comprising:
(a) forming a valve core of a metal material, the valve core including a head and an elongated stem extending away from the head with a curved region connecting the head and the elongated stem, a central guide region of the elongated stem being substantially uniform in outer dimension and free of any undercut;
(b) micro finishing surface portions of the valve core of step (a); and
(c) using a coating process to apply and bond a multi-layer coating to micro finished surface portions of the valve core, including the central guide region of the elongated stem.
